(19) United States
(12) Patent Application Publication
(10) Pub. No.: US 2012/0301232 A1
(43) Pub. Date: Nov. 29, 2012

(54) Container for transportation of solids

(76) Inventor: Harry Joseph Wulff, Columbia, MO (US)

(21) Appl. No.: 13/116,903

(22) Filed: May 26, 2011

(51) Int. Cl. B65G 51/00

(52) U.S. Cl. 406/184

(57) ABSTRACT

The purpose of the invention is to convey solid particles within containers that are transported through a liquid-filled pipeline and are discharged without contact with the liquid. Each container is made of material, molded as an open-top circular cylinder with a solid bottom and removable lid; container sides have integral metal ribs and tapered about 1 percent outwards from bottom to top. In assembly line fashion, containers are essentially continuously filled with the solid particles, to precise weight between 80 to 1200 pounds; filled containers are securely sealed then automatically launched into the pipeline. The carrier fluid velocity is sufficient to propel containers to discharge. At the pipeline outlet, carrier-liquid separates from the containers, the lid removed automatically, and the solids discharged into storage or other shipping vessels. The empty containers are reused in the long pipeline transportation system.

The purpose of the invention relates to the transportation of solids over long distances by the use of a pipeline with flowing liquid (such as water) which carries or propels a container full of solids, such as particles of coal, ash, or other gravelly matter.

The transportation of solids in large quantities for long distances between shipping and delivery points often uses railroads, overland conveyor belts and trucks. In recent years the access to solids: fuels, minerals and other commodity materials and wastes has become more difficult because of the inaccessibility of these solids. Currently, the existence of trucks, railroads and conveyors to many remote locations is limited. However, the demand and need for resources is increasing as well as transportation systems to return wastes to depleted mines. Recently, industries in four continents are considering hydraulic capsule type of pipelines for the transport of solids.

### BRIEF DESCRIPTION OF DRAWINGS

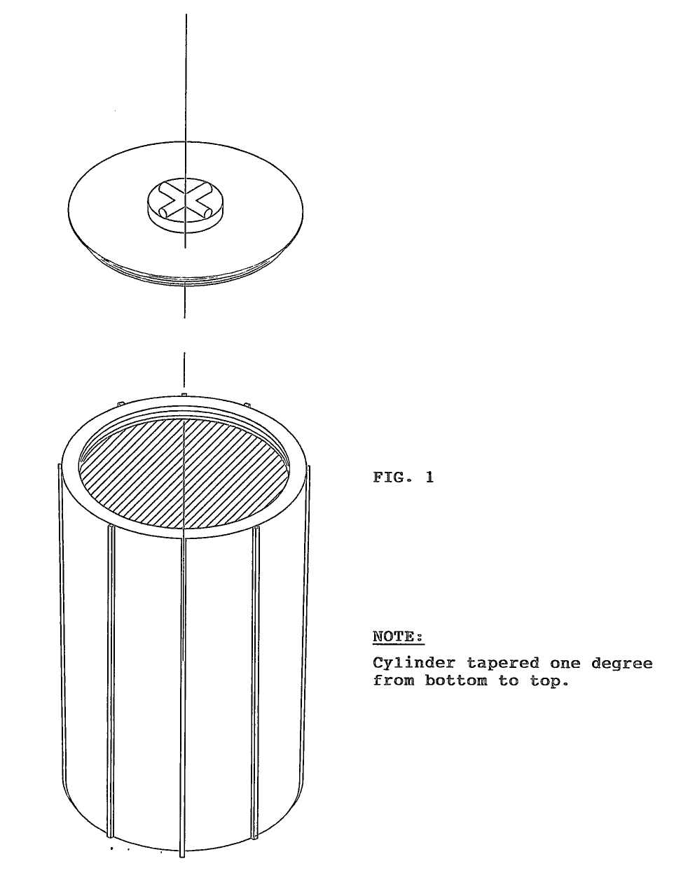

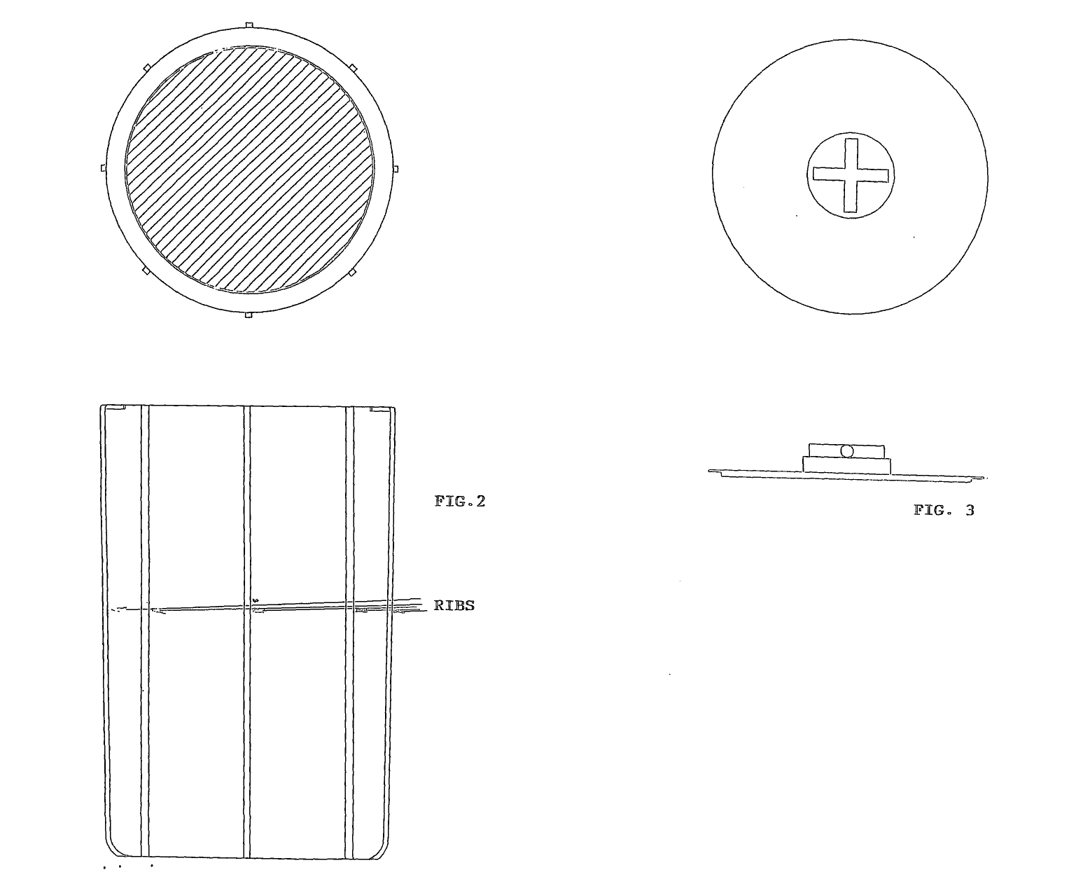

The solids container consists of a material molded with the form of an open-top circular cylinder. FIG. 1 is a perspective view of my invention. The material is rigid or semi-rigid in physical characteristics. Along the sides of the container are slats made of tubes sliced in half to form half rounds or ribs integral with the side wall, see FIG. 2 These slats may be of varying distances apart, say 1 to 4 inches. The container is closed by a lid that covers the top opening, see FIG. 3. The lid is a circular shape with a cross-type slot, which seals the container by compression over the outside of the container and has ferromagnetic backing. The ferromagnetic backing is used as a marker for its position in the pipeline and its orientation. The overall size of the container is in accord with the pipe diameter. The aspect of the container is greater than 1 and less than 5.

The container is carried by water, or other liquid, flowing at velocities between one and ten feet per second. Typically, the container may travel distances from 10 to 300 miles and the container used repeatedly. The containers are essentially impermeable to water and separate solids carried by the container from pressurized water (or liquid) used to transport the container though a long pipeline. After usage in the pipeline, a large number of containers may be nested, or stacked together due to a one degree taper from bottom to top.

The empty container, without lid, is precisely filled with solid particles to a specified weight. The filling is done rapidly by automated machinery; each container, of many, is moved to the filling location by automatic conveyor belt. The fill mechanism includes a dust control enclosure for each container. After the container is filled, it is weighed. The lid is placed on the top of the container and pressed and turned with appropriate mechanical force to seal the container filled with solid particles. The container filled with solid particles is automatically moved away from the filling machine to the next station.

1. The containers loaded with solids travel in the direction of flow (water or other liquid) with their velocity allowing the containers to be suspended, or travel, with minimal contact with the inside surface of pipeline.

2. The containers are reusable, essentially impermeable to water and constructed of rigid or semi-rigid materials. The solids loaded in the containers may weigh from 80 to 1200 pounds (mass).

3. The weight ratio of containerized solids to water (or carrier liquid) ranges from 0.8 to 1.2. The solids are particulates with diameters less than 1/12 the container diameter.

4. The containers are tapered one degree from bottom to top.
